(19) United States
(12) Patent Application Publication
(10) Pub. No.: US 2011/0055780 A1
(43) Pub. Date: Mar. 3, 2011

(54) METHOD FOR INTEGRATED CIRCUIT DESIGN VERIFICATION IN A VERIFICATION ENVIRONMENT

(76) Inventor: Martti VENELL, Helsinki (FI)

(21) Appl. No.: 12/836,934

(22) Filed: Jul. 15, 2010

(30) Foreign Application Priority Data
Aug. 27, 2009 (FI) 20095884

(51) Int. Cl. G06F 9/455

(52) U.S. Cl. 716/106

(57) ABSTRACT

The invention relates to a method. In the method a reference model and a register transfer level model are obtained to a test bench. To a user is presented at least one wave diagram in a user interface on a display of an apparatus. A time interval associated with an input vector is determined based on a first type of user input. A random number range is associated with the time interval based on a second type of user input. The generation of an input data file is started for at least one test case for the reference model and the register transfer level model. Random numbers within the random number range are generated, the random numbers being stored within the input data file. The test cases are executed using either of the models.

### BACKGROUND OF THE INVENTION

1. Field of the Invention

The invention relates to Integrated Circuits (IC) design and development. Particularly, the invention relates to a method for integrated circuit design verification in a verification environment.

2. Description of the Related Art

Integrated Circuits (IC) are manufactured on the surface of a semiconductor substrate material. The manufacturing is based on imaging, deposition and etching steps where patterns from predesigned photo masks are projected on a light-sensitive chemical resist on the surface to produce an exposure pattern. Thereupon, chemical processes are applied to engrave the exposure pattern into the substrate underneath the photo resist. A semiconductor wafer may undergo dozens of photolithographic cycles. The photo masks are produced by printing graphical models of different layers of the circuit. The graphical models in turn may be produced from a logical model of the circuit. In order to avoid producing faulty circuits, it is necessary to be able to test the logical model of the circuit to be manufactured. The logical model may in turn be generated from a Register Transfer Level (RTL) model or the logical model may directly be an RTL model. The RTL model may also be produced from or accompanied by an even higher-level reference model, which describes the function of the circuit on an algorithmic level.

In addition to fixed design circuits there are Field-Programmable Gate Arrays (FPGA), which allow the programming of gates on a universal purpose IC after the IC has been manufactured. An FPGA contains gates that may be configured to emulate any fixed IC.

For the programming of FPGAs and the producing of RTL or reference models, a number of Hardware Description Languages (HDL) has been developed. Examples of such HDLs comprise the Very High Speed Integrated Circuits Hardware Description Language VHSIC HDL (VHDL), SystemC and SystemVerilog. The models are in turn tested using test beds that run sequences of predefined test cases. A model being tested is often referred to as a Design Under Test (DUT). The test cases are inputted to the models by the test bed, which also collects output responses from the models. The test bed may be defined at least partially using a test language, that is, a hardware verification language such as OpenVera, SystemC and SystemVerilog. The VHDL may also be used to define a test bed for testing a model. The test case related input data may be defined in or generated from a description language.

The problem in existing testing systems is that a user must manually define test case data, which takes a lot of time. It is important to achieve a wide coverage of branches in the models through the selection of right test cases. In manual table testing it may be difficult to observe sections in hardware description language that are possible sources of error and that require thorough testing. Similarly, if a user must manually check the resulting output data it may be difficult to observe errors. It is also particularly difficult to debug errors resulting from timing related problems. Therefore, it would be beneficial to be able to define multiple test cases with an effort required in the definition of a single test case. Further, it would be beneficial to be able to perform measurements involving the outputs of a wide range of test cases.

### SUMMARY OF THE INVENTION

The invention relates to a method, comprising: obtaining at least one of the reference model and the register transfer level model; presenting to a user at least one wave diagram in a user interface on a display of an apparatus; determining a time interval associated with an input vector based on a first type of user input; associating a random number range with the time interval based on a second type of user input; starting the generation of an input data file for at least one test case for the at least one of the reference model and the register transfer level model; generating at least one random number within the random number range, said random number being stored within the input data file; and executing the at least one test case using the reference model and the register transfer level model.

The invention relates also to an apparatus, comprising: at least one memory configured to store a design under test comprising at least one of a reference model and a register transfer level model; and at least one processor configured to obtain at least one of the reference model and the register transfer level model, to present to a user at least one wave diagram in a user interface on a display of an apparatus, to determine a time interval associated with an input vector based on first type of user input, to associate a random number range with the time interval based on second type of user input, to start a generation of an input data file for at least one test case for the at least one of the reference model and the register transfer level model, to generate at least one random number within the random number range, said random number being stored within the input data file, and to execute the at least one test case using the reference model and the register transfer level model.

The invention relates also to an apparatus, comprising: means for obtaining at least one of the reference model and the register transfer level model; means for presenting to a user at least one wave diagram in a user interface on a display of an apparatus; means for determining a time interval associated with an input vector based on a first type of user input; means for associating a random number range with the time interval based on a second type of user input; means for starting the generation of an input data file for at least one test case for the at least one of the reference model and the register transfer level model; means for generating at least one random number within the random number range, said random number being stored within the input data file; and means for executing the at least one test case using the reference model and the register transfer level model.

The invention relates also to a computer program comprising code adapted to perform the following steps when executed on a data-processing system: obtaining at least one of the reference model and the register transfer level model; presenting to a user at least one wave diagram in a user interface on a display of an apparatus; determining a time interval associated with an input vector based on a first type of user input; associating a random number range with the time interval based on a second type of user input; starting the generation of an input data file for at least one test case for the at least one of the reference model and the register transfer level model; generating at least one random number within the random number range, said random number being stored within the input data file; and executing the at least one test case using the reference model and the register transfer level model.

The invention relates also to a computer program product comprising: obtaining at least one of the reference model and the register transfer level model; presenting to a user at least one wave diagram in a user interface on a display of an apparatus; determining a time interval associated with an input vector based on a first type of user input; associating a random number range with the time interval based on a second type of user input; starting the generation of an input data file for at least one test case for the at least one of the reference model and the register transfer level model; generating at least one random number within the random number range, said random number being stored within the input data file; and executing the at least one test case using the reference model and the register transfer level model.

In one embodiment of the invention, an input vector, that is, an input vector value instance to be provided to a model may be defined as a test transaction or a number of test transactions. The input vector values may be generated based on random number constraints defined for the vector.

In one embodiment of the invention, an input vector represents an input pin or a set of interrelated input pins that are in an external interface of a model. The input pin or the set of interrelated input pins may be provided to at least one chip defined as part of the model. An input vector may have any number of bits. An input vector value is an instance of values assigned to the input vector bits that are valid during a given time interval. The time interval may be, for example, a given number of clock cycles.

In one embodiment of the invention, the user interface related information presentation and user input collection tasks are performed in by a user interface entity in a verification test bench.

In one embodiment of the invention, the user interface entity in the verification test bench of the apparatus is configured to determine a second time interval associated with an output vector based on third type of user input, to associate a protocol pattern with the second time interval and to detect the protocol pattern in an output of the output vector.

In one embodiment of the invention, a protocol checking entity in a verification test bench is further configured to stop the execution of the at least one test case, in other words, simulation in response to the detecting of the protocol pattern and to cause a user interface entity to displaying a message on the display. The message may comprise also input or output vector values at the time of the stopping of the execution.

In one embodiment of the invention, a protocol checking entity in a verification test bench is further configured to incrementing a counter in response to the detecting of the protocol pattern and the user interface entity is further configured to display the counter to the user on the display.

In one embodiment of the invention, the user interface entity is configured to define an assertion as part of the protocol pattern, said assertion comprising at least one comparison clause, said comparison comprising a comparison operator and at least two of a constant, an arithmetic or a bitwise logic operation and a time interval reference, said time interval reference referring to a third time interval associated with a second output vector.

In one embodiment of the invention, a result comparison entity in the verification test bench is further configured to produce output data of the executing of the at least one test case, to compare output data from the reference model to output data in the register transfer level and to determine a discrepancy as a result of the comparison.

In one embodiment of the invention, the user interface entity is further configured to determine from user input via the user interface a second associated input vector for the input vector and aligning automatically the time interval to a value interval in the second associated input vector.

In one embodiment of the invention, wherein the at least one test case is defined in a verification test bench.

In one embodiment of the invention, the user interface entity is further configured to forming computer program code for detecting the at least one protocol pattern, to compiling the computer program code and to link the compiled computer program code to the verification test bench or the at least one of the reference model or the register transfer level model. The compiling may be to an intermediate language or to machine code.

In one embodiment of the invention, at least one of the reference model and the register transfer level model are defined in a hardware verification language.

In one embodiment of the invention, a protocol checker is configured to determine the success of the testing using at least one predetermined expected output.

In one embodiment of the invention, the apparatus comprises a permanent storage, which may be comprised in a secondary memory, for example, as a disk partition, directory or a file. The permanent storage may be at least part of the storage space of a computer readable medium such as a flash memory, a magnetic or an optic disk.

In one embodiment of the invention, the computer program is stored on a computer readable medium. The computer readable medium may be a removable memory card, magnetic disk, optical disk or magnetic tape.

In one embodiment of the invention, the at least one processor is configured to execute the user interface entity, the result comparison entity and the protocol checking entity.

The embodiments of the invention described hereinbefore may be used in any combination with each other. Several of the embodiments may be combined together to form a further embodiment of the invention. A method, an apparatus or a computer program to which the invention is related may comprise at least one of the embodiments of the invention described hereinbefore.

The benefits of the invention is related to improved testing of designs, which further provides improved quality of ICs or FPGA. With the invention there may be fewer bugs in the designs. Also the time required in the generating of test cases may be reduced. With the invention it may also be possible to test also the performance of a design automatically.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating design verification environment in one embodiment of the invention;

FIG. 2A is a flow chart illustrating a design verification method in one embodiment of the invention;

FIG. 2A is a flow chart illustrating a design verification method in one embodiment of the invention; and

FIG. 3 is a user interface diagram illustrating fields in a user interface in one embodiment of the invention.

### DETAILED DESCRIPTION OF THE EMBODIMENTS

Reference will now be made in detail to the embodiments of the present invention, examples of which are illustrated in the accompanying drawings.

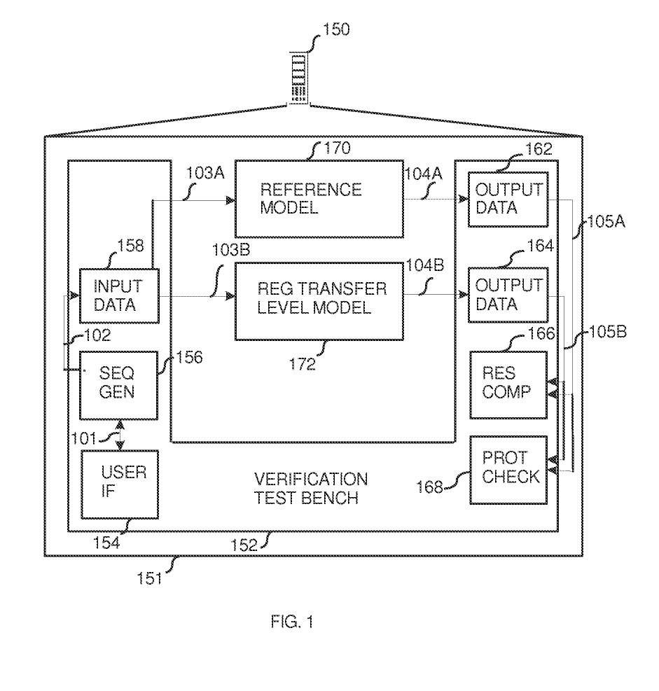

FIG. 1 is a block diagram illustrating design verification environment in one embodiment of the invention. In FIG. 1 there is illustrated an apparatus 150, which comprises at least one processor and at least one memory. The at least one memory comprises a primary memory and a secondary memory. The primary memory is, for example, a Random Access Memory (RAM). The secondary memory may be, for example, a magnetic disk, an optic disk, a magneto-optic disk or a flash-memory. The internal functions of apparatus 150 are illustrated with a box 151. The at least one memory in apparatus 150 is configured to store a verification test bench 152. Verification test bench 152 comprises a user interface entity 154, a sequence generation entity 156, a result comparison entity 166 and a protocol checking entity 168. Verification test bench 152 produces input data file 158. Input data file 158 is used to provide input data to a DUT, which comprises a reference model and an RTL model. The execution of the DUT produces output data files 162 and 164. At least one memory in apparatus 150 is configured to store a reference model 170 and a Register Transfer Level (RTL) model 172. Models 170 and 172 are referred to as the DUT. Verification test bench 152 may be, for example, an executable file to which modules such as Dynamically Linked Libraries (DLL) representing models 170 and 172 are linked statically or dynamically. Models 170 and 172 may also be executed using an interpreter (not shown) in association with verification test bench 152. Verification test bench 152 may be implemented, for example, using a high-level programming language such as C, C++, C#, SystemC or OpenVera. Model 170 may be implemented, for example, using SystemC, C++ or VHDL. Model 172 may be implemented, for example, using VHDL or SystemVerilog. Input data file 158 may be defined, for example, using a specific test case definition language such as the e-language or it may be an unstructured text file. The output data files 162 and 164 may, for example, conform to a proprietary format or standardized format or be unstructured text files.

The starting point for the design verification method is that source code files for models 170 and 172 are produced for the use of verification test bench 152.

A user of verification test bench 152 interacts with user interface entity 154. User interface entity 154 provides a user interface, which may be e.g. a window, a user interface form or a display screen. The user interface comprises at least one wave diagram, which represents a sequence of input values of an input vector as a function of time. The user may define at least one time period in the wave diagram for any input vector. A time period in the wave diagram of an input vector may be called a cell. The user specifies a start time and an end time for at least one cell. The cell start and end time may be snapped to a value boundary in another input vector. Thereupon, the user assigns at least one range constraint for the at least one cell. The at least one range constraint is assigned so that user interface entity 154 prompts the user for the at least one range constraint. Each range constraint comprises a lower limit and a higher limit within the domain of the input vector to which the range is associated. The user may also define an alternating value pattern for an input vector such as a clock input vector. The user may also define a constant value for an input vector for a specific time period. After the wave diagrams for the input vectors necessary for a test sequence are defined, they are provided from user interface entity 154 to sequence generation entity 156, as illustrated with arrow 101. Thereupon, sequence generation entity 156 generates at least one test case. A test case comprises a sequence of input vector values corresponding to the constraints defined by the user for the wave diagrams. In a test case generated a cell for an input vector with a random value range constraint is replaced with an actual value from the range.

In one embodiment of the invention, the user of verification test bench 152 interacts with user interface entity 154 to define at least one protocol pattern. User interface entity 154 provides a user interface for the specifying of the protocol pattern. The user interface may, for example, be a window, a user interface form or a display screen. The user interface for the specifying of the protocol pattern comprises a space for at least one wave diagram, which represents a sequence of output values of an output vector as a function of time. The user may define at least one cell using the user interface. A cell in this context represents a time period on the output of a given output vector. A cell has a given start time and a given end time specific to the cell. The cell may be defined on a given wave diagram space. The user may define multiple cells relating to a single output vector. The user may also define cells on a number of output vectors. The user may define an assertion to any cell. An assertion comprises at least one comparison clause, each of which results to true or false. Each comparison clause may comprise at least two of a constant, an arithmetic or bitwise logic expression, a timeslot reference, in addition to a comparison operation such as =,<,>,=<,>= and < >. An arithmetic or bitwise logic operation may comprise at least one cell reference. A cell reference refers to any cell on the same or another output vector. In other words an assertion is a check that each comparison clause in the cell provides a true Boolean value. If the comparison clauses match, that is, each comparison clause provides the Boolean value true, a counter may be incremented or a message may be outputted to a log file. The user may also specify that a message is output to the log file if the assertion fails.

After or during the test case generation, sequence generation entity 156 writes to input data file 158 the at least one test case. The input vector values in input data file 158 may be represented as a sequence of carriage return or line feed terminated lines or records, where each record comprises a start clock value, the values for the other input vector values during the time from the start clock value to a clock value in the next line or record. The writing of data to input data file 158 by sequence generation entity 156 is illustrated with arrow 102.

After the generation of input data file 158 verification test bench 152 executes reference models 170 and 172. During the execution, verification test bench 152 provides input vector values from input data file 158 to models 170 and 172, as illustrated with arrows 103A and 103B. Further, during the execution models 170 and 172 generate data to output data files 162 and 164, as illustrated with arrows 104A and 104B, respectively. The output data may be represented as a sequence of carriage return or line feed terminated lines or records, where each record comprises a start clock value and the output vector values during the time from the start clock value to a clock value in the next line or record. The execution of test cases may be implemented, for example, by compiling of models 170 and 172 into object files by verification test bench 152 or otherwise by the user. Each test case execution may comprise the calling of a method, a procedure or a subroutine with input vector values corresponding to a single record or line in input data file 158. The execution of a test case may provide an output record or line to one of the output data files 162 and 164, depending on the model being executed. For example, the method, procedure or subroutine executed may return output vector values, which are used by verification test bench 152 to write a single record or line to one of the output data files 162 and 164. Models 170 and 172 provide output vector values for output data files 162 and 164, respectively.

During or after the execution of models 170 and 172, result comparator 166 compares the output records from output data files 162 and 164, as illustrated with arrows 105A and 105B. For each mismatch, an error message may be outputted to standard output or a log file.

In one embodiment of the invention, a protocol checker entity 168 may observe the compliance of output data records or lines in one of output data files 162 and 164 to check that output vector values comply with a protocol. The compliance is checked, for example, by verifying that the at least one protocol pattern defined by the user is present in the output data files 162 and 164. For each successful assertion a counter may be increased with one or any other value. There may be a counter for each assertion. In other words, an assertion is a check that each comparison clause in the cell provides a true Boolean value. If the comparison clauses match, that is, each comparison clause provides the Boolean value true, a counter may be incremented or a message may be outputted to a log file. The user may also specify that a message is output to the log file if the assertion fails. The assertion counter values are written to at least one memory within apparatus 150. After the checking the user may read the assertion counter values using a user interface provided by user interface entity 154.

In one embodiment of the invention, output data values may not be provided, that is, output data files 162 and 164 are not produced by the execution. Instead, only assertion counters are updated and written to a file stored in a memory in apparatus 150 for later inspection by the user.

Apparatus 150 comprises a processor, a primary memory and a secondary memory. There may be more than one processor. A processor may comprise multiple cores. Apparatus 150 may also comprise a network interface such as, for example, an Ethernet card. Primary memory may be a Random Access Memory (RAM). Secondary memory is a non-volatile memory such as, for example, a magnetic or optical disk. When the processor executes functionalities associated with the invention, the memory comprises entities such as, for example, user interface entity 154, sequence generation entity 156, result comparison entity 166 and protocol checker entity 168. The entities within apparatus 150 in FIG. 1 may be implemented in a variety of ways. They may be implemented as processes executed under the native operating system of the network node. The entities may be implemented as separate processes or threads or so that a number of different entities are implemented by means of one process or thread. A process or a thread may be the instance of a program block comprising a number of routines, that is, for example, procedures and functions. The entities may be implemented as separate computer programs or as a single computer program comprising several routines or functions implementing the entities. The program blocks are stored on at least one computer readable medium such as, for example, a memory circuit, memory card, magnetic or optic disk. Some entities may be implemented as program modules linked to another entity. The entities in FIG. 1 may also be stored in separate memories and executed by separate processors, which communicate, for example, via a message bus or an internal network within the network node. An example of such a message bus is the Peripheral Component Interconnect (PCI) bus.

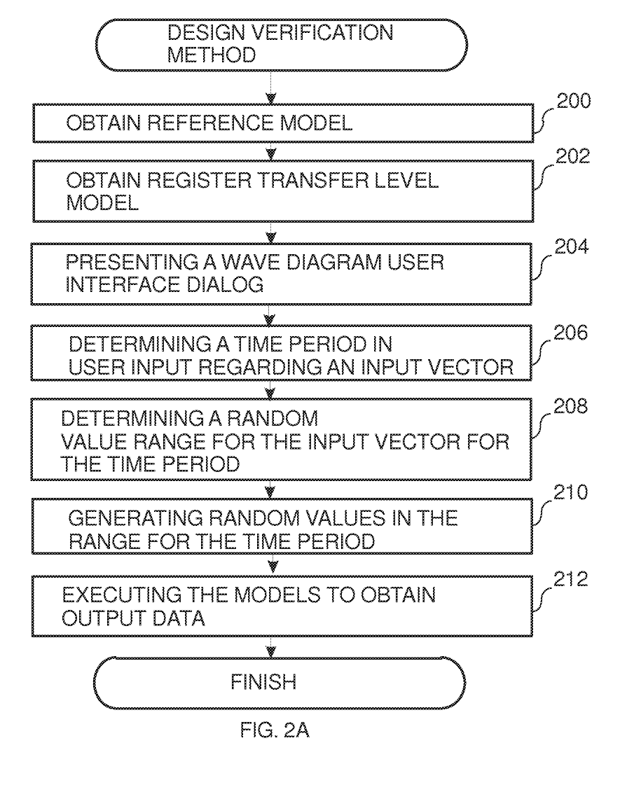

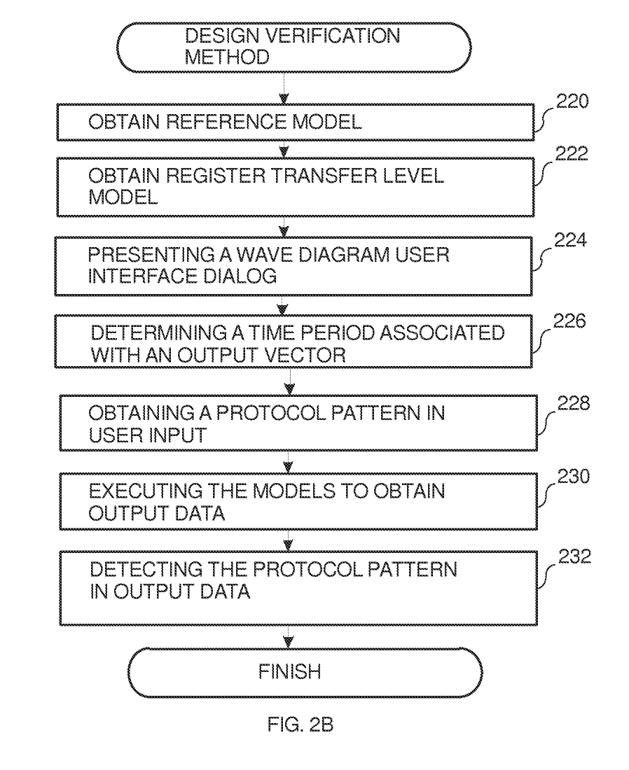

FIG. 2A is a flow chart illustrating a design verification method in one embodiment of the invention.

At step 200 a reference model of a design is obtained. In one embodiment of the invention, the reference model is a model of the design in a high-level programming language, which defines the behavior of the design in terms of decisions based on input vector values directly or indirectly. In one embodiment of the invention, the reference model is defined in association with a verification test bench.

At step 202 a register transfer level model of the design is obtained. In one embodiment of the invention, the register transfer level model is defined in association with a verification test bench.

At step 204 a wave diagram is presented to a user in a user interface dialog. The wave diagram may be initially empty. There is a wave diagram for each input vector in the design. A vector may have 1 to many bits. The user may populate the wave diagram with different values by selecting different input values for each vector at different time intervals. A standard alternating bit pattern may be generated automatically for a clock vector. The user may select input vectors and time intervals from a two-dimensional sheet using, for example, a mouse.

At step 206 the user determines an arbitrary time interval for a given input vector. Such an arbitrary time interval associated with an input vector may be called a cell. The user may select input vectors and time intervals from a two-dimensional sheet using, for example, a mouse in order to define a cell. The cell is determined from the user input by the verification test bench.

At step 208 the user enters a random value range associated with a cell selected using the user interface dialog. The random value range is detected by the verification test bench. The user may specify to verification test bench that each new random may is generated at each clock cycle. The user may also define any other repeating time period after the elapsing of which a new random value is generated for the input vector.

At step 210 the generation of random values is performed for the input vector associated with the cell containing the random value range. The generation of random value may happen before the execution of the test defined by the user using the wave diagram during steps 204-208. The generation of random values may also happen during the execution of test cases for models 170 and 172 so that at the user specified time periods or at clock cycles a new random value is generated in the random value range specified. The new random value is then applied as input to the input vector.

At step 212 the models 170 and 172 are executed by the verification test bench to obtain output data. Thereupon, the method is finished.

FIG. 2B is a flow chart illustrating a design verification method in one embodiment of the invention.

At step 220 a reference model of a design is obtained. In one embodiment of the invention, the reference model is a model of the design in a high-level programming language, which defines the behavior of the design in terms of decisions based on input vector values directly or indirectly. In one embodiment of the invention, the reference model is defined in association with a verification test bench.

At step 222 a register transfer level model of the design is obtained. In one embodiment of the invention, the register transfer level model is defined in association with a verification test bench.

At step 224 a wave diagram is presented to a user in a user interface dialog.

In one embodiment of the invention, the wave diagram may be initially empty. There is a wave diagram for each output vector in the design. A vector may have 1 to many bits. A standard alternating bit pattern may be generated automatically to represent a clock input vector. The user may select output vectors and time intervals associated with them from a two-dimensional sheet using, for example, a mouse.

At step 226 the user determines an arbitrary time interval for a given output vector.

In one embodiment of the invention, such an arbitrary time interval associated with an output vector may be called a cell. The user may select output vectors and time intervals from a two-dimensional sheet using, for example, a mouse in order to define a cell. In the two dimensional sheet a horizontal axis represents the time and lines in the vertical axis different output vectors. The cell is determined from the user input by the verification test bench.

At step 228 a protocol pattern is obtained in user input.

In one embodiment of the invention, the protocol pattern is an assertion. The assertion is a cell, which has a specific start time and end time and which is associated with an output vector. The assertion comprises at least one comparison clause, each of which results to true or false. Each comparison clause may comprise at least two of a constant, an arithmetic or logic expression, a timeslot reference, in addition to a comparison operation such as =,<,>,=<,>= and < >. An arithmetic or logic operation may comprise at least one cell reference. A cell reference refers to any cell on the same or another output vector. In other words an assertion is a check that each comparison clause in the cell provides a true Boolean value. If the comparison clauses match, that is, each comparison clause provides the Boolean value true, a counter may be incremented or a message may be outputted to a log file. The user may also specify that a message is output to the log file if the assertion fails.

In one embodiment of the invention, a protocol pattern may comprise a fixed value such as, for example, a flag.

In one embodiment of the invention, the protocol patterns are used to form assertion code that is compiled into the at least one of the reference model and the register transfer level model.

At step 230 at least one of the reference model and the register transfer level model is executed to obtain output data. The models are executed with input data provided earlier in the method.

In one embodiment of the invention, the test cases may be executed multiple times. Each time new random values may be generated to the cell defined by the user to have random value ranges.

At step 232 a protocol pattern is detected in output data. The output data is obtained as a result of the execution of at least one of the reference model and the register transfer level model.

In one embodiment of the invention, execution of the test cases, that is, simulation is terminated in response to the detecting of the protocol pattern.

In one embodiment of the invention, a counter associated with a protocol pattern is incremented each time the protocol pattern is detected in output data. In one embodiment of the invention, an assertion counter is incremented as the condition clauses in the assertion evaluate to true. This is performed during the execution or after the execution of the at least one of the reference model and the register transfer level model. In other words, each time the assertion evaluates to true, a counter associated with the assertion is incremented.

At the end the counter values or the detection of the protocol pattern and associated output and input vector values may be presented to the user. Thereupon, the method is finished.

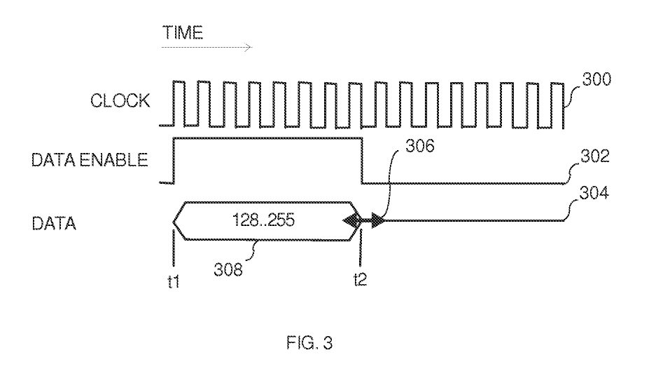

FIG. 3 is a user interface diagram illustrating fields in a user interface in one embodiment of the invention.

In FIG. 3 there is illustrated a user interface dialog, which comprises three input vectors, namely clock, data enable and data. The clock input sequence is illustrated with wave diagram 300. The data enable input sequence is illustrated with wave diagram 302. The data input sequence is illustrated with wave diagram 304. The user has defined a cell 310 associated with the data input vector and thus with wave diagram 304. Thereupon, the user has entered a random value range for cell 310. The random value range for cell 310 is 128-255 as illustrated in FIG. 3. Thus, during the execution of at least one of the register transfer level model and the reference model a random value in the range 128-255 is generated during the time interval of cell 310. The test may be executed multiple times so that multiple random values are generated, one for each execution. The user may adjust the time interval of a cell, as illustrated with arrow 306. The user may have bound the data enable input vector value to the time interval of the cell 310 so that the user does not need to adjust the value time interval separately. The start time of cell 310 is t1 and end time is t2.

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (e.g., voice, modem, and the like), wireless communications media, one or more wireless communications networks, cellular communications networks, G3 communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware art(s). For example, the functionality of one or more of the components of the exemplary embodiments can be implemented via one or more hardware devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

It is obvious to a person skilled in the art that with the advancement of technology, the basic idea of the invention may be implemented in various ways. The invention and its embodiments are thus not limited to the examples described above; instead they may vary within the scope of the claims.

1. A method, comprising:
obtaining at least one of the reference model and the register transfer level model;
presenting to a user at least one wave diagram in a user interface on a display of an apparatus;
determining a time interval associated with an input vector based on a first type of user input;
associating a random number range with the time interval based on a second type of user input;
starting the generation of an input data file for at least one test case for the at least one of the reference model and the register transfer level model;
generating at least one random number within the random number range, said random number being stored within the input data file; and
executing the at least one test case using the reference model and the register transfer level model.

2. The method according to claim 1, the method further comprising:
determining a second time interval associated with an output vector based on third type of user input;
associating a protocol pattern with the second time interval; and
detecting the protocol pattern in an output of the output vector.

3. The method according to claim 2, the method further comprising:
stopping the execution of the at least one test case in response to the detecting of the protocol pattern; and
displaying a message on the display.

4. The method according to claim 2, the method further comprising:
incrementing a counter in response to the detecting of the protocol pattern; and
displaying the counter to the user on the display.

5. The method according to claim 2, the method further comprising:
defining an assertion as part of the protocol pattern, said assertion comprising at least one comparison clause, said comparison comprising a comparison operator and at least two of a constant, an arithmetic or a bitwise logic operation and a time interval reference, said time interval reference referring to a third time interval associated with a second output vector.

6. The method according to claim 1, the method further comprising:
producing output data of the executing of the at least one test case;
comparing output data from the reference model to output data in the register transfer level; and
determining a discrepancy as a result of the comparison.

7. The method according to claim 1, the method further comprising:
determining from user input via the user interface a second associated input vector for the input vector; and
aligning automatically the time interval to a value interval in the second associated input vector.

8. The method according to claim 1, wherein the at least one test case is defined in a verification test bench.

9. The method according to claim 8, the method further comprising:
forming computer program code for detecting the at least one protocol pattern;
compiling the computer program code;
linking the compiled computer program code to the verification test bench or the at least one of the reference model or the register transfer level model.

10. The method according to claim 1, wherein at least one of the reference model and the register transfer level model are defined in a hardware verification language.

11. An apparatus, comprising:
a memory configured to store a design under test comprising at least one of a reference model and a register transfer level model; and
at least one processor configured to obtain at least one of the reference model and the register transfer level model, to present to a user at least one wave diagram in a user interface on a display of an apparatus, to determine a time interval associated with an input vector based on first type of user input, to associate a random number range with the time interval based on second type of user input, to start a generation of an input data file for at least one test case for the at least one of the reference model and the register transfer level model, to generate at least one random number within the random number range, said random number being stored within the input data file, and to execute the at least one test case using the reference model and the register transfer level model.

12. An apparatus, comprising:
means for obtaining at least one of the reference model and the register transfer level model;
means for presenting to a user at least one wave diagram in a user interface on a display of an apparatus;
means for determining a time interval associated with an input vector based on a first type of user input;
means for associating a random number range with the time interval based on a second type of user input;
means for starting the generation of an input data file for at least one test case for the at least one of the reference model and the register transfer level model;
means for generating at least one random number within the random number range, said random number being stored within the input data file; and
means for executing the at least one test case using the reference model and the register transfer level model.

13. A computer program comprising code adapted to perform the following steps when executed on a data-processing system:
obtaining at least one of the reference model and the register transfer level model;
presenting to a user at least one wave diagram in a user interface on a display of an apparatus;
determining a time interval associated with an input vector based on a first type of user input;
associating a random number range with the time interval based on a second type of user input;
starting the generation of an input data file for at least one test case for the at least one of the reference model and the register transfer level model;
generating at least one random number within the random number range, said random number being stored within the input data file; and
executing the at least one test case using the reference model and the register transfer level model.

14. The computer program according to claim 13, wherein said computer program is stored on a computer readable medium.

15. The computer program according to claim 14, wherein said computer readable medium is a removable memory card, a holographic memory, a magnetic disk or an optical disk.
